(19) United States
(12) Patent Application Publication
(10) Pub. No.: US 2003/0055838 A1
(43) Pub. Date: Mar. 20, 2003

(54) Data storing method and data storing structure

(76) Inventors: Barbara Rosen, Nacka (SE); Stefan Lembke, Koping (SE); Soren Molin, Stockholm (SE)

Correspondence Address: Rolf Fasth, Fasth Law Offices, 189 Curtis Drive, Longview, WA, 98632-5374, US

(21) Appl. No.: 10/239,448

(22) PCT Filed: Mar. 22, 2001
(86) PCT No.: PCT/SE01/00632

(30) Foreign Application Priority Data
Mar. 22, 2000 (SE) 0000984-5
Dec. 22, 2000 (SE) 0004831-4

(51) Int. Cl. G06F 7/00

(52) U.S. Cl. 707/103 R

(57) ABSTRACT

For storing data a single data file (9) or table having records of a uniform format is used. Each line in the table indicates an attribute value belonging to an object. In the lines also other information on the object and attribute value is provided such as the type of the attribute. This table format has great advantages when handling data in the table. In various processing steps (12-17) original data (5) in the table can be processed, thereby expanding the table by new records. The processing is made using fixed rules and rule data indicated in table shape that can easily be changed by a user who then does not have to know how different tables are linked to each other. From the produced expanded data table (9) desired information can be very easily extracted.

### TECHNICAL FIELD

The present invention relates to a method of processing and storing data in a database structure and a structure for storing data.

### BACKGROUND

When storing information in a data format for various objects the storing can be performed by means of relational tables. In this type of storing the tables used are objects. The objects can then be any type of objects about which one wants to store information, for example persons, providers, customers, etc. In such methods of data storing, columns are provided that identify and indicate the properties of the different objects, for example family name, surname, sex, and address, see FIG. 1.

However, a number of different problems are associated with this conventional method of storing data. Thus, an extensive analysis and recoding is required in the case where an existing table structure is to be changed in some way. Specialists having knowledge of the system are required in the case where new tables are to be formed. It is difficult to assign secrecy to different individual attributes in the objects, etc.

### SUMMARY OF THE INVENTION

It is an object of the present invention to provide a data storing structure that overcomes the problems associated with conventional methods of storing data.

It is another object to provide a data storing structure that allows the data table to be easily expanded to achieve an expanded data table from which desired information can be very easily retrieved.

These and other objects are provided by a data storing structure and a method of forming and modifying data storing structures as will be described in the following and as defined by the accompanying independent claims.

For storing data a single data file or table is used comprising rows, lines or records having a uniform format, i.e. having the same fields. Each line of the table has a predetermined field that indicates an attribute value associated with an object specified in at least one different field. In the lines also other information is provided about objects and attribute value such as the type of the attribute. This table format has large advantages when manipulating data in the table. In different processing steps thus original data in the table can be processed, thereby expanding the table by new records. The processing is made using fixed rules and rule data indicated in table form that can be easily changed by a user who then does thus not have to have knowledge about the way in which different tables are linked to each other as in conventional relational databases. From the produced expanded data table desired information can be very easily retrieved.

In the description the following terms will be hereinafter used:

Data owner: identification of the owner of a record or of the organization unit/function to which a record belongs.

Data version: the real condition that the data owner associates with data in a record, for example production data, test data, etc.

Object type: category of objects that is reflected by the data content, for example person, account, part, and customer.

Object value: unique identity value for a considered object type, for example a personal identification number for the type person or an account number for the type account.

Object: a term for the combination of the concepts object type and object value.

Period type: category of time period when data are or start to be valid, for example year, month, day, etc.

Period value: unique time indication for a considered period type written in a suitable date format, for example ccyymmdd for the period type day.

Period: name for the combination of the concepts period type and period value.

Attribute type: category of data that represent a concept and the occurrences thereof. For example customer name is a property for the object type customer and family name and year of birth properties of the object type person.

Measurement unit: a quantity for numerical attribute types, for example the currency Swedish crowns for the attribute type monthly salary.

Attribute value: an actual representation, i.e. a numerical or alphanumerical value, belonging to the set of allowed values for a considered attribute type. For example, 30,000 is possible value for the attribute type annual salary expressed in the unit dollar.

Production date: information indicating the time when the record was created.

### BRIEF DESCRIPTION OF THE DRAWINGS

The invention will now be described in greater detail by way of non-limiting examples and with reference to the accompanying drawings in which:

FIG. 1 shows conventional relational tables according to the state of the art,

FIG. 2 shows a single uniformly constructed table for simple storing of information,

FIGS. 3a-3d show tables comprising an example of an application of the uniform table shown in FIG. 2,

FIGS. 4a-4c show tables comprising another application of a uniform table,

FIG. 5a is a block diagram of a method of processing data in an original database and retrieving desired information from the database,

FIGS. 6, 7 and 8 show input data, rule data and output data for an extraction step,

FIGS. 9 and 10 show rule data and output data for a step comprising a translation one to one,

FIGS. 11 and 12 show rule data and output data for a step comprising translation one to many,

FIGS. 13, 14, 15 and 16 show input data, calculation attribute data, operand attribute data and output data for a calculation step,

FIGS. 17, 18, 19, 20 and 21 show input data, rule data, new object data before identity production, new object data before removal of records and accumulation and new object data after removing records and accumulation, i.e. output data respectively for a step comprising object production,

FIGS. 22, 23 and 24 show input data, rule data and output data for a step comprising a step for changing measurement unit, and

FIG. 25 shows an actually stored table in which some fields have been excluded.

### DESCRIPTION OF A PREFERRED EMBODIMENT

In FIG. 1 tables 101 and 103 a conventional relational database are shown. Each table is associated with an object for which the table is designed to store data. In the table 101 that in this example is concerned with different customers, in a first column a customer number 105 is provided, in second column a customer name 107, in a third column the customer sex 109, in a fourth column a purchase amount 111, in a fifth column a number of purchases 113, and in seventh column a customer category 115. In the table 103 that in this example is concerned with different customer categories, in a first column a customer category 117 is indicated, in a second column a name of a customer category 119 and in a third column a priority 121.

However, the method of storing data as illustrated in FIG. 1 is associated with disadvantages as has been described above. Thus, an extensive analysis and recoding is required in the case where an existing structure is to be changed in some way. Specialists having knowledge of the system are required when new objects are to be formed. It can be difficult to assign secrecy to different individual attributes in the objects, etc.

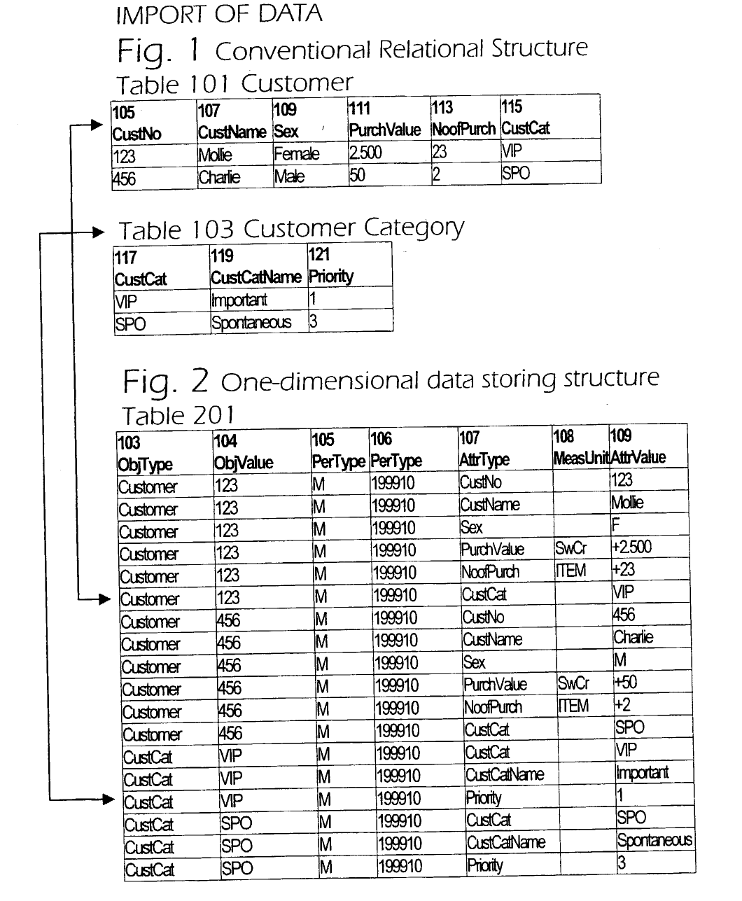

In FIG. 2 an example of a method is illustrated that in some respects is more efficient for storing the same information as in FIG. 1 and then in a single table 201. Each individual column value in the tables in FIG. 1 corresponds to a line in the table 201. All objects are stored in the same table, certainly resulting in considerably more records requiring more data storage space but allowing a simple manipulation of stored data. In order to increase the clarity the lines in the table according to the example in FIG. 2 are arranged so that the topmost lines of the table contain information related to a first object type, in this example customers 203, and the next following lines contain information related to a second type of object, in this example customer categories 205. This sequential order of the records in the table is not necessary but can contribute to creating an overview of the data storing structure. However, if it from some aspect would be advantageous to arrange the lines in the table in FIG. 2 in a different sequential order it can of course be made.

The table 201 contains for each record a number of fields that are here termed:

ObjType 103: contains the object type described above

ObjValue 104: contains the object value described above

PerType 105: contains the period type described above

AttrType 107: contains the attribute type described above

MeasUnit 108: contains a value of the measurement unit described above

AttrValue 109: contains the attribute value described above

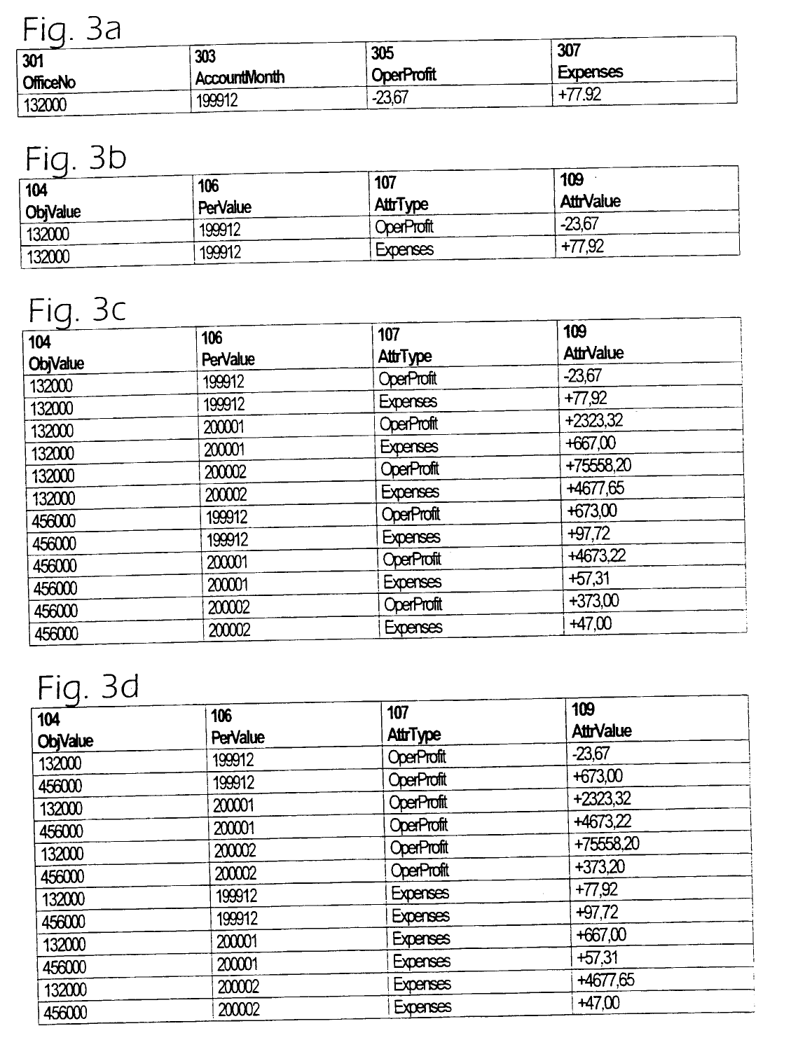

An example of using the data storing structure illustrated in FIG. 2 will now be described with reference to FIGS. 3a-3d. In the example storing operating profits for a bank office is shown. The following information in the examples according to FIGS. 3a-3d does not have to be stored since it is the same for all records:

Object type: in the example only the information of one bank office is shown which otherwise would have been identified by its bank office number.

Period type: in the example accounting is made monthly that is expressed according to the data format ccyymm.

Measurement unit: in the example all amounts of money are given in Swedish crowns.

In the example the following information is to be stored

Office number: 132000

Accounting month: 199912

Operating profit: −23,67

Expenses: +77,92

For the purpose of enhancing the clarity first in FIG. 3a is illustrated how the operating profit for a bank office can be stored in a conventional relational table. Thus in a first column 301 an office number is stored, in second column 303 the account month is stored, in a third column 305 the operating profit is stored and in a third column 307 the amount of expenses is stored.

In FIG. 3b is illustrated how the same information is stored in a table modified in the same way as has been described above so that the two more specific column values correspond to one line in the new table. If the structure of the table in FIG. 3b is compared to the relational table in FIG. 3a the following can be observed:

The field 104, ObjValue, corresponds to the key field of the relational table, i.e. the field OfficeNo 301.

The field PerValue 106 corresponds to the field AccMonth 303.

I the field AttrType 107 field names are stored for the fields that contain the more specific information in the table in FIG. 3a, i.e. the names “OperProfit” and “Expenses”.

In the field AttrValue 109 this more specific information is stored as taken from the fields OperProfit 305 and Expenses 307 in the table in FIG. 3a.

As time passes new information is monthly recorded for all the bank offices of the bank. For the bank offices Nos. 132000 and 456000, during the period 199912-200002 the information according to FIG. 3c has been stored in a table of the same type as that illustrated in FIG. 3b.

In order to be capable of efficiently making searches it can be necessary to have the data storing structure sorted in different ways. An examples of how the table looks in the case where the data storing structure is sorted in the sequential order according to AttrType, ObjValue and PerValue is shown in FIG. 3d.

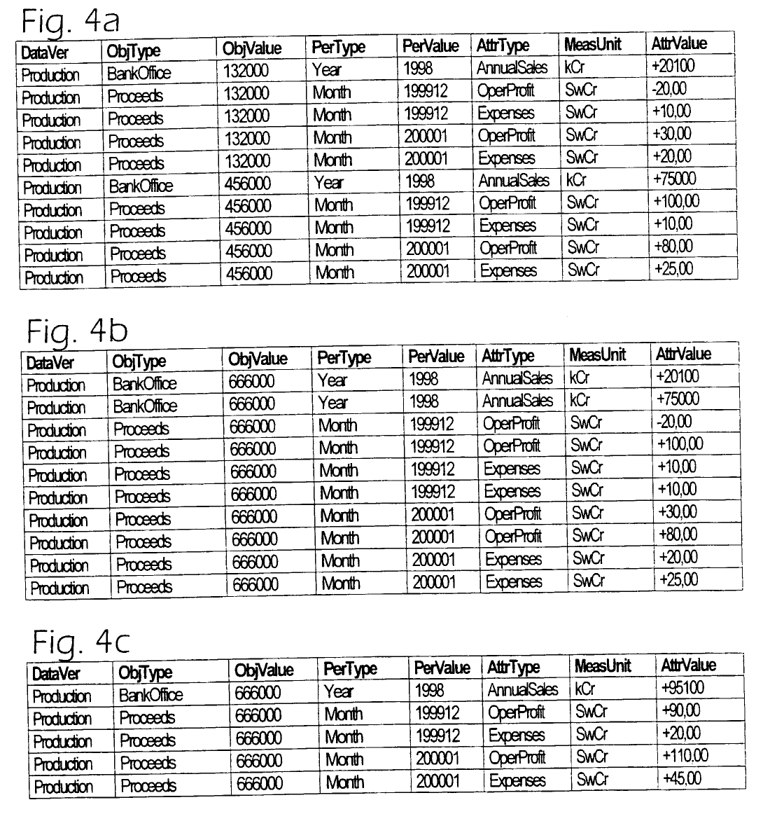

In FIGS. 4a-4c an example is shown of the way in which the uniform data storing structure can be used to simplify manipulation of data. The example illustrates how a general change of an existing data storage can be easily made. It is assumed that the bank offices Nos. 132000 and 456000 are to be merged and then will obtain the new bank office No. 666000. The original data storing structure is that shown by the table of FIG. 4a which is designed in substantially the same way as the tables in FIGS. 3b-3c but in which the records have been supplemented by fields related to the version in the column having the title DataVer, relating to the object type in the column ObjType, the period type in the column PerType and the measuring unit in the column having the title MeasUnit, compare also the table 201 in FIG. 2.

After the merging all objects of the types BankOffice and OperProfit having the object values 132000 and 456000 will have the new object value 666000, see the column ObjValue in FIG. 4b, this resulting in the table in FIG. 4b after sorting the table according to ObjType, ObjValue and AttrType.

After data in the column ObjValue have been summed all the lines in the data storage that have the same identities are summed, see FIG. 4c. The value change in the column of attribute or data contained value can be observed that now is the summed values for the previous offices Nos. 132000 and 456000.

In another preferred embodiment the descriptions of different categories and items in the data storing structure are coded by a unique code that is preferably defined in the very data storing structure. Thereby, the data storing structure can be made independent of national languages, resulting in that the same basic data storing structure can be used in different language environments.

By using the data storing structure as described herein various advantages are obtained compared to more conventional methods of storing data on an electronic medium. Thus, general manipulations of data that are made by a computer system can be easily made. They can be made in an easily understandable way that increases its ease of use to users, etc. It will be described in greater detail hereinafter.

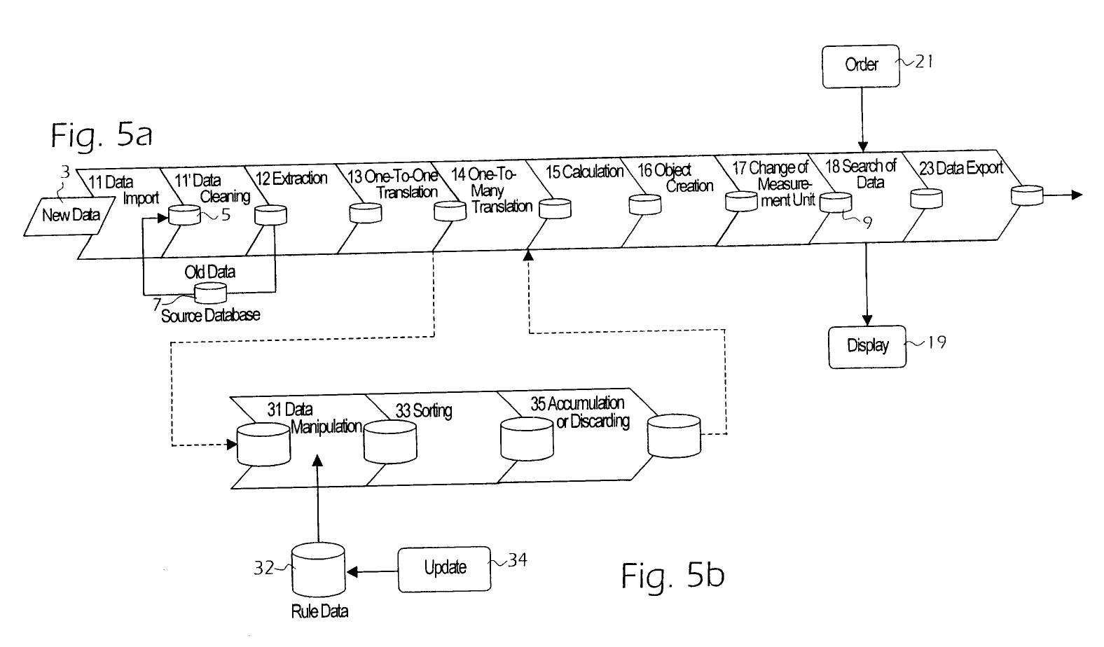

In FIG. 5a generally, as a schematic picture is illustrated how a database having the format indicated above can be built. The start data here comprise a data file 3 carrying new information. It is imported in a data import step 11 and is assembled with information in an old database 7, here called source database, having a format that substantially agrees with the format described above, for example with reference to FIG. 4a, possibly supplemented by more fields. Thereupon it is checked in a step 11′, that the records in the assembled database contain valid information, such as by checking the format of date information. The records can then be changed when required to a format predetermined for each field. Thereafter, the new database 5 is stored separately on a suitable medium, as indicated at 7, in order to be used as the old database, when new information at a later occasion again will be entered.

The produced new data records can then have the format illustrated by the table in FIG. 6. In addition to the fields described above in each record a field 101 is provided for the data owner having the title DataOwner, a field 102 having the title DataVer, a field 110 for creation time having the title CreatTime and a field 111 for transaction type having the title TransType. In the last field 111 is indicated whether the record belongs to source data, i.e. is of the type input to the system, either from an old database or from new data that have been entered into the system, or has been obtained by the processing procedures to be described hereinafter.

In the data records the special information is stored in the field attribute value 109 whereas other fields contain information associated with this information, i.e. it indicates the type thereof, the object with which it is associated, the time when it is valid, when it was created, how it was created, etc.

The produced source database 5 is then converted to an expanded database by supplementing it with further records, all records being run through and processed in a plurality of steps. From the expanded database or data storage desired information can then be retrieved in a very simple way.

In the first steps new records are produced associated with the same object but having new attributes. In a first block 12 new records are produced by extraction, in a second block 13 new records are produced by translation one to one, also called direct assignment, in a third block 14 new records are produced by translation one to many, also called recursive assignment, and in a fourth block 15 new records are produced by calculations. Thereupon, in a fifth block 16 new objects can be produced, by direct object production and by period production. In a sixth, last block 17 new records can be produced within the same object by changing measurement unit.

Inside each of the processing steps 12-17 the creation of new records is similar, as is illustrated by the detailed view of FIG. 5b. An incoming record is processed in a step 31 according to fixedly programmed rules and therein simple tables are used, stored as is illustrated at 32 containing information defining rule data. New records are produced that are sorted in the block 33 and finally, in a step 35 the records now produced can be united to form a single record by accumulation, the values in the field attribute value being then accumulated, or by discarding records, so that only the new created record having the first or latest value in the field period value remains. The new records are thereupon entered in the database expanding it and have their transaction type, as indicated in the field TransType 111, changed to indicate the step of processing in which the record was produced so that they can thereby be distinguished from source data.

After having finally produced the data storage 9, after the step 17 including change of measuring units, information therein can be used in different ways, such as for displaying records in the data storage, see block 19 in FIG. 5a, to extract suitable records by an ordering function 21, or to export the data storage, see the block 23.

Now the different processing steps will be described in detail.

Extraction

Data shown in the table in FIG. 6 will now be used when describing how new attributes are formed in the extraction step 12. The purpose of the function in this step is to produce new attributes by extracting a subset of existing attribute values. This function can be suitably used for such attributes as e.g. personal identification number, zip code, SNI-code, estate number in which “hidden” information can exist.

Input data are constituted of

records in a data file, the information thereof stored according to the one-dimensional data storing structure described above, i.e. the combined source data file 5, see the example of FIG. 6.

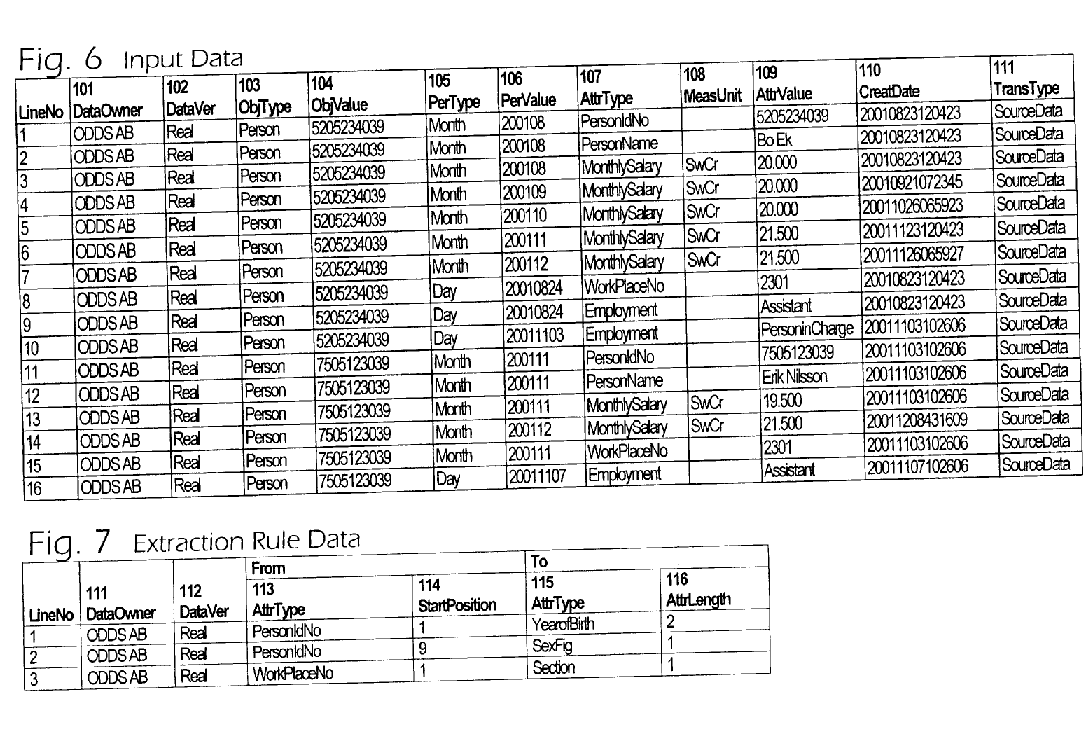

extraction rule data specified as values in a field in a data storing structure or table, an example thereof shown in FIG. 7. The rule data table contains six fields selected among those existing in this data storing structure.

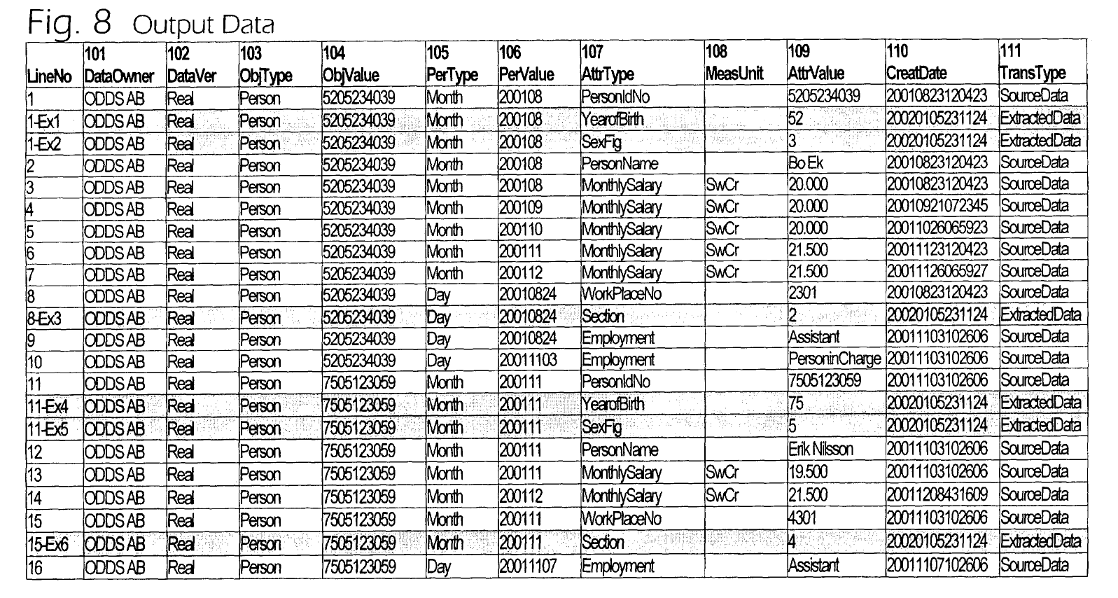

Output data are constituted of a data file comprising the records of the input data file to which are added new extracted records that are stored according to the one-dimensional data storing structure, see FIG. 8.

When processing a record in the input data file the record is compared to a line in rule data file, thereafter to the next line in the rule data file, etc., and then the following is always made

Extraction if the contents of the fields 101, 102 and 107 in the table of FIG. 6 are equal to the contents of the fields 111, 112 and 113 respectively in the rule data table of FIG. 7.

Irrespectively of hit or not the processed record, the input data record, is written to the output data file, i.e. is entered in the table of FIG. 8.

When extracting, i.e. for the case of equality according to what is said above, the input data record is copied whereupon

the content of the field 107 is replaced by the content of the field 115,

the content of the field 109 is replaced by that portion of the content in the field 109 which is defined by the contents of the fields 114 and 116,

the content of the field 110 is replaced by the creation time, i.e. the current date and time of day,

the content of the field 111 is replaced by a code indicating that the record is created in the extraction step 11.

These rules are fixed, independent of the contents of the rule data table according to FIG. 7.

### EXAMPLE 1

In the example shown in FIGS. 5, 6 and 7 the following is made.

The attribute type IdNo in line No. 1 in FIG. 6 is extracted according to records or lines Nos. 1 and 2 in the rule data table of FIG. 7, for each line a new record or a line being extracted from the value 5205234039 in the first record in the table of FIG. 6. Then, in the first new record the following is entered:

attribute type=YearBirth, attribute value=52 (start position 1, length 2)—see line 1-Ex1 in the new table of FIG. 8.

In the second new record is entered:

attribute type=GenusFigure, attribute value=3 (start position 9, length 1)—see line 1-Ex2 in the table of FIG. 8.

According to line No. 3 in the rule data table of FIG. 7 the attribute type WorkPlaceNo is to be extracted and this can be done for line No. 8 in the input data table of FIG. 6. Then, a new line or record is extracted or created from the value 2301. In the new record is entered:

attribute type=Section, attribute value=2 (start position 1, length 1)—see line 8-Ex3 in the table of FIG. 8.

In the new records the contents of all fields, except in those mentioned specifically above and except the two last fields, are set equal to the contents of the corresponding fields in the records for which the extraction is made.

Translation One to One

In the step of translation one to one 13 the purpose is to produce new attributes by translating an existing value to another value. This function can suitably be used for organization changes, standardizing codes or production of new codes based on existing values.

Input data are constituted of

the records in the data file output from the preceding step which are stored according to the one-dimensional data storing structure, see the table of FIG. 8.

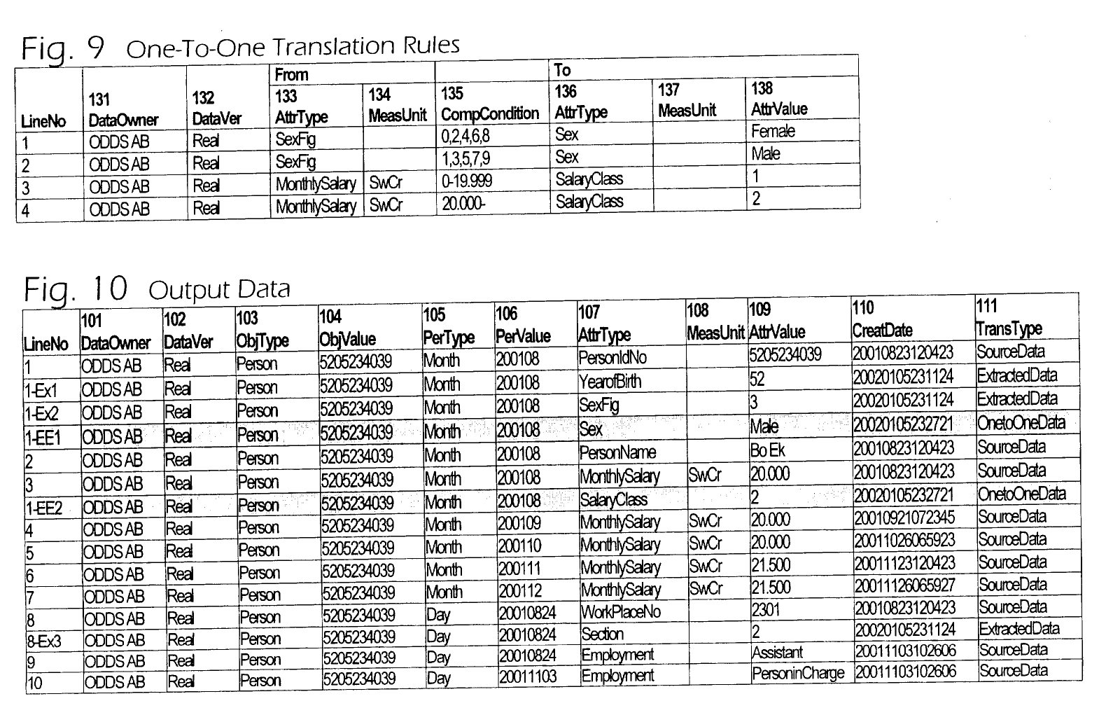

rule data for translation one to one stored according to a uniform storing structure, see the example of FIG. 9. Rule data are as here as above specified as values in a field in a table. The rule data table contains eight fields selected among those that are provided in the general storing structure, compare FIGS. 6 and 8.

Output data are, as in the precedings steps, constituted of a data file, see the table of FIG. 10, comprising the records of the input data file and new records obtained in the translation one to one, the records being stored according to the general one-dimensional data storing structure as described above.

In translating, a record or a line in the input data file according to FIG. 8 is compared to a line in the rule data table of FIG. 9 and a translation is to be made in the case where the contents of the fields 101, 102, 107 and 108 in the record of the input data file are equal to the contents of the fields 131, 132, 133 and 134 respectively of the record in the rule data table of FIG. 9 and if the content of the field 109 in the record of input data file fulfils the comparing condition defined by the content of the field 135 in the rule data record.

Irrespectively of hit or not, i.e. irrespectively of the fact whether all the conditions in the comparison are fulfilled, the input data record is written in an unchanged shape to the output data file, as shown in FIG. 10.

For the case of hit the input data record is copied to form a new record whereupon

the content of the field 107 in the new record is replaced by the content of the field 136 in the rule data record,

the content of the field 108 in the new record is replaced by the content of the field 137 in the rule data record,

the content of the field 109 in the new record is replaced by the content of the field 138 in the rule data record,

the content of the field 110 in the new record is replaced by the current time,

the content of the field 111 in the new record is replaced by a code defining that the record was created in a translation one to one.

The steps described above are repeated for the same input data record and each of the following lines the rule data table. Thereupon the steps are repeated for all following records in the input data file including a comparison to each line of the rule data table in order to create new records. After all new possible records have being created in this step a removal of similar records is made by saving, from the created records that have the same contents in the fields for object and attribute, i.e. of the fields object type, object value, attribute type and attribute value, only that record which has the oldest attribute value as indicated by the content of the field period value 106. Of course, the contents of the fields period type 105 must also be equal.

### EXAMPLE 2

In the line created by extraction and denoted by 1-Ex2 in FIG. 8 the attribute type SexFig is to be translated according to line No. 2 in the rule table of FIG. 9 so that a new line is produced. Then the following is entered:

attribute type=Sex, attribute value=Male

in the new line denoted by 1-EE1 in FIG. 10. No removal of similar records is needed.

In the lines Nos. 4-7 in the input data file according to FIG. 8 the attribute type MonthlySal is to be translated according to line 4 in the rule data table of FIG. 9 so that only one new line having the oldest time period remains in the output data file after making a removal of the similar records. The produced single new line has the reference 1-EE2 in the table of FIG. 10 and in this line the following substitutions have been made:

attribute type=SalaryClass, attribute value=2—see line 14

Translation One to Many

In the third step 14, translation one to many, the purpose is to produce new attributes by translating an existing value to many other values. This function can suitably be used when producing multidimensional summing levels or in order to handle multidimensional relations such as e.g. organization structures and product structures.

Input data are as above

the data file, see FIG. 10, that has been obtained as the output data file from the preceding step, in this case the step of translation one to one, and in the similar way as above it is assumed that data in the file are stored according to the one-dimensional data storing structure.

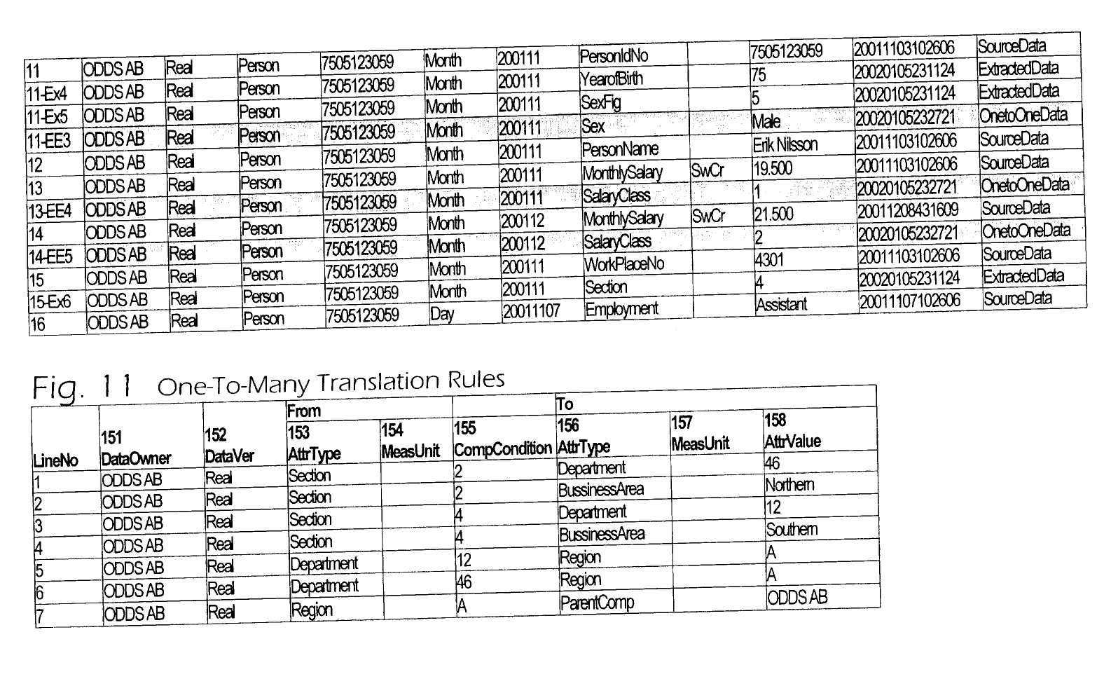

translation rule data defined in a table format as above according to a storing structure that appears from the table of FIG. 11.

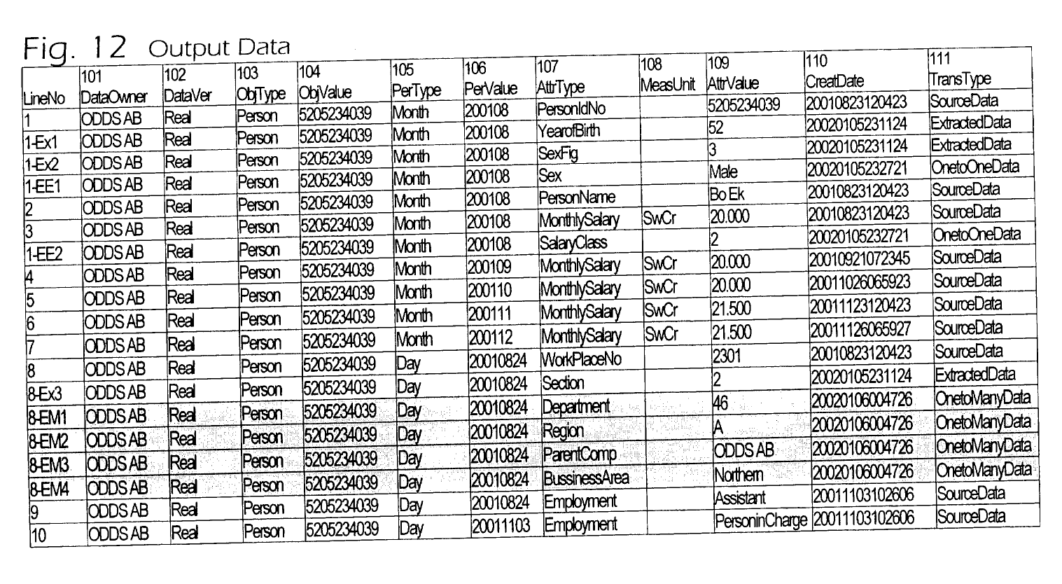

Output data are constituted of a data file, see FIG. 12, that includes the data of the input data file expanded by created new records. The data of the output data file are stored according to the one-dimensional data storing structure.

The processing is in principle made as above. One record at the time in the input data file is compared to a record at a time in the rule data table, whereupon this is repeated for each record in the rule data table and for each record of the input data file. In the comparison a new record is created if

the contents of the fields 101, 102, 107 and 108 in the input data record are equal to the contents of the fields 151, 152, 153 and 154 respectively of the rule data record, and

the content of the record 109 of the input data record fulfils the comparing condition defined by the contents of the field 155 in the rule data table.

Irrespectively of hit or not the input data record is written to the output data file. For the case of a hit the input data file is copied to form a new record whereupon

the content of the field 107 in the new record is replaced by the content of the field 156 in the rule data record,

the content of the field 108 in the new record is replaced by the content of the field 157 in the rule data record,

the content of the field 109 in the new record is replaced by the content of the field 158 in the rule data record,

the content of the field 110 is replaced by the current time, and

the content of the field 111 is replaced by a code indicating the step in which the record was produced.

If the contents of the fields 156, 157 and 158 in the created new record are equal to the contents of the fields 153, 154 and 155 respectively in the next line of the rule data table again a new record is created by copying the created new record and thereupon the replacement according to the description above is made. Thereupon again a new record is created if the conditions given above are fulfilled. This is repeated including a comparison for each row of the rule data table until the conditions thereof are not fulfilled. Finally, all created records are examined for making a removal, so that among the new records which all have the same contents in the fields for object and attribute only that record is kept which has the oldest or youngest attribute value. Alternatively, all created records are examined for an accumulation, and then for all new records having the same contents in all fields except in the field for the attribute value, the values in the fields for attribute values are summed. Thereupon, a new record is created, agreeing with the created new records except that the value in the field for attribute value is replaced by the summed value. Thereupon, all those created new records are removed from which the sum has been formed.

Calculation

After the step 14 comprising translation one to many the step 15 including calculation is executed, the purpose of which is to produce new attributes by calculating new values based on existing values and from values produced in the calculation.

Input data are as above

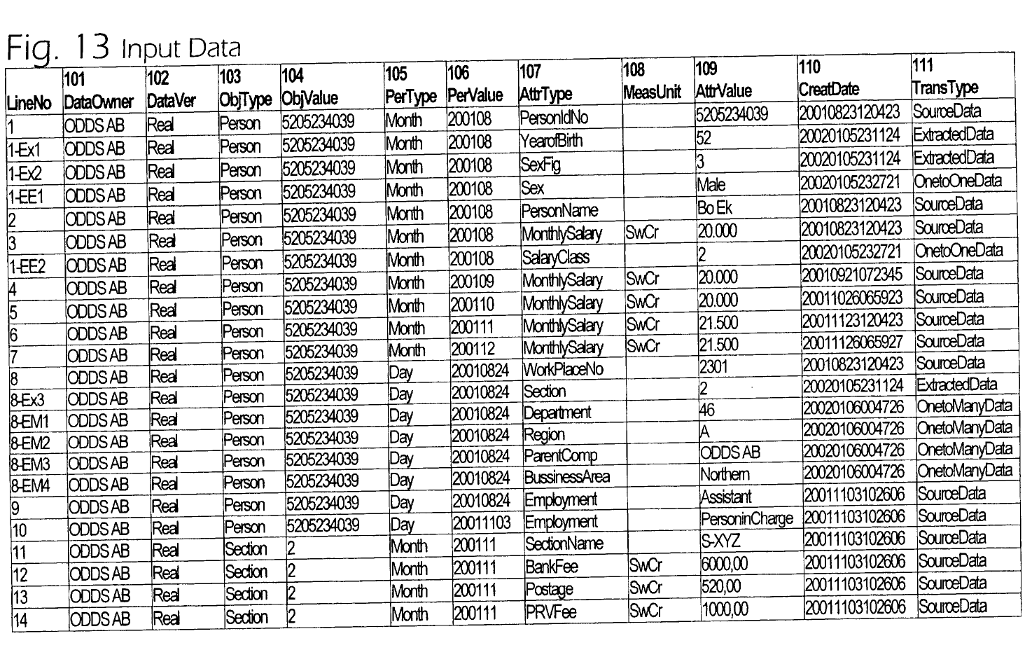

the output data file from the preceding step in which data are stored according to the one-dimensional data storing structure, see FIG. 13.

calculation attributes indicated by a table structure as above, see FIG. 14.

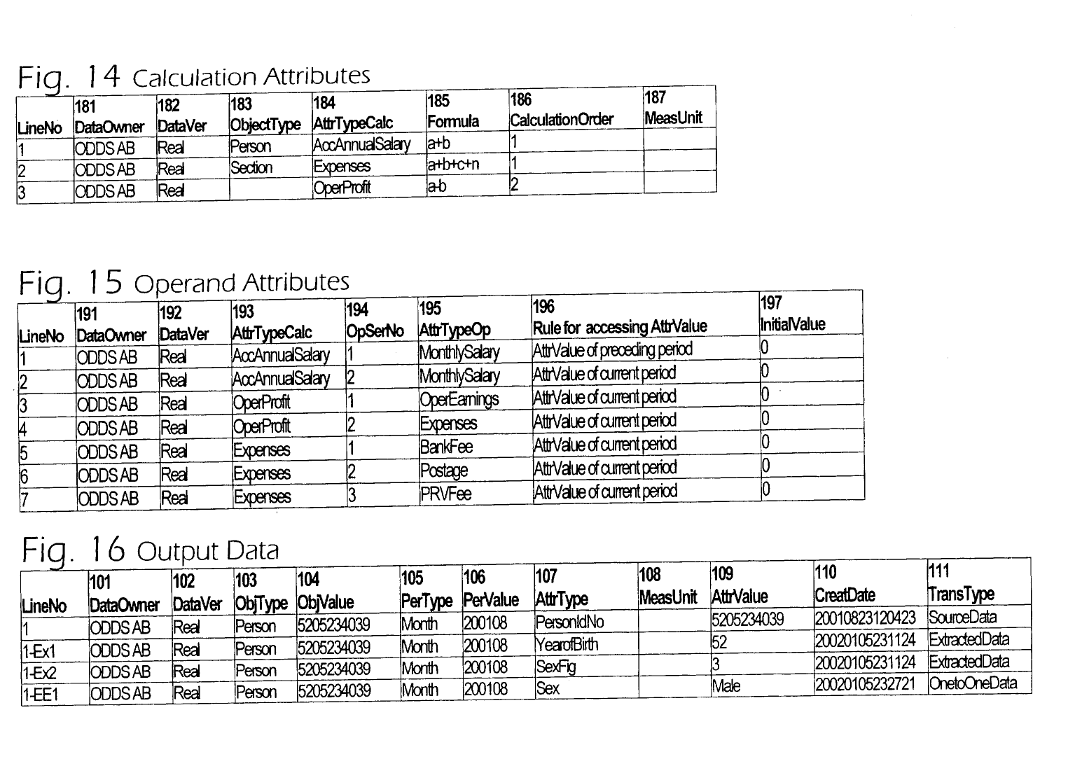

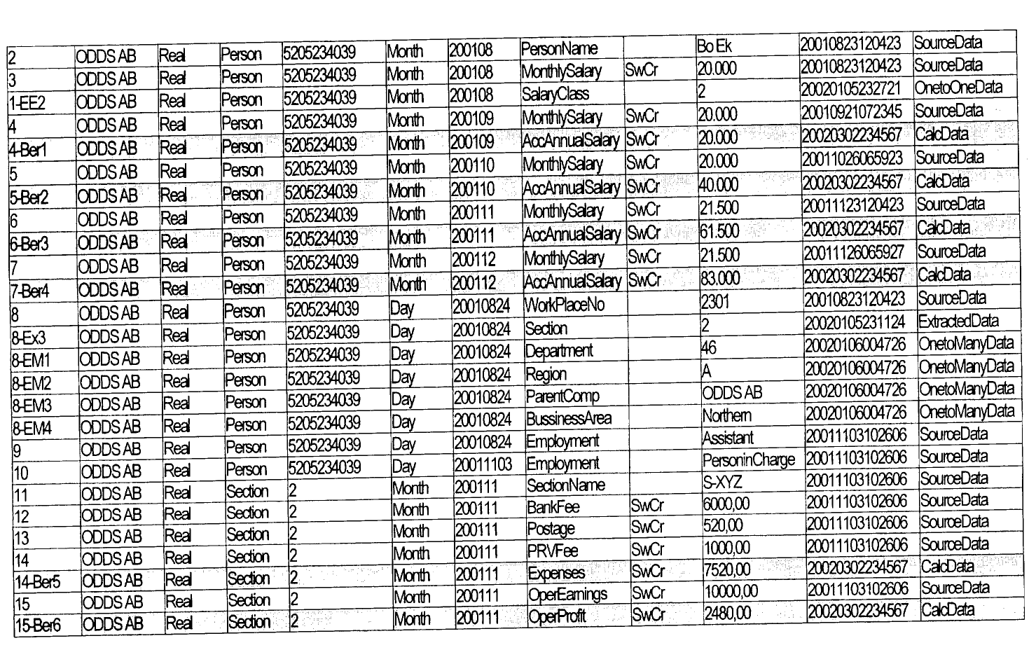

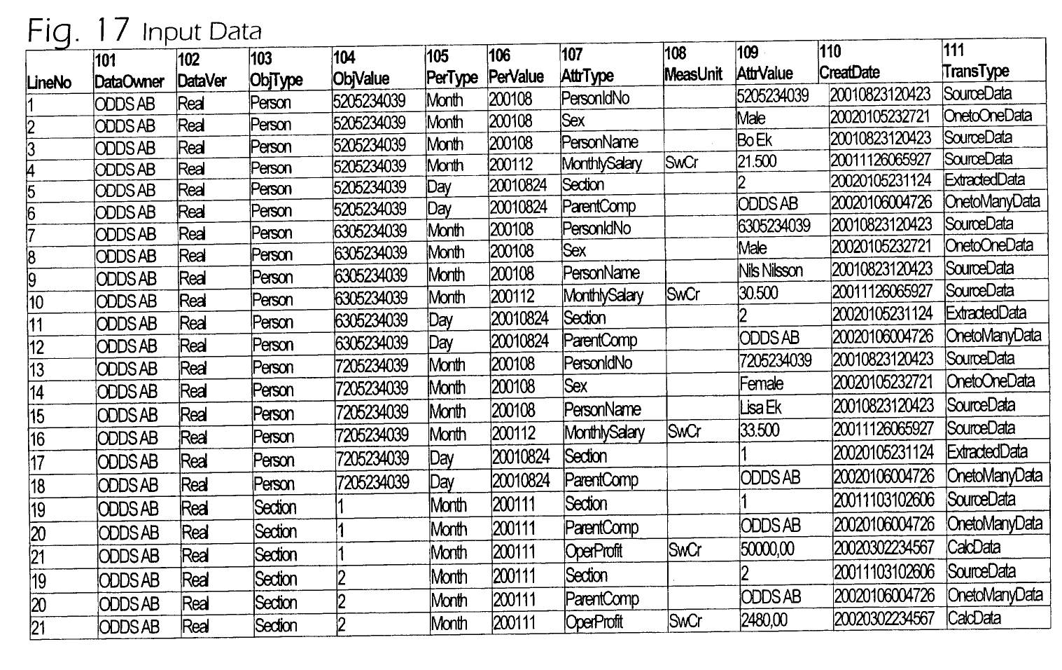

operand attributes indicated by another table structure, see FIG. 15.

Output data are as above a data file including the data of the input data file and the new records, see FIG. 16.

In the calculation first the calculation order indicated in the field 186 in the table of FIG. 14 is determined by analyzing how the operand attributes in the fields 195 having the title AttrTypeOp in the table of FIG. 15 relate to each other. For example, Expenses must first be calculated before OperProfit can be calculated. If no calculation order is required the value of the field 185 is assigned the value 1.

The records in the input data file, see FIG. 13, are first sorted in increasing order according to the values of the fields 101, 102, 103, 104, 107, 105, 106 in this sequential order. Those lines in the input data file which do not indicate numerical values in their fields 109 for attribute value are written directly to the output file. If the contents of the fields 101, 102, 103 in a record in the input data file are equal to the contents of the fields 181, 182 and 183 respectively in a record in the calculation attribute table, a calculation is performed according to the calculating order indicated in the field 186 in the same table. For each attribute that is to be calculated according to the content of the field 184 in the calculating attribute table the attribute operands thereof are provided in the table of FIG. 15.

If the contents of the fields 181, 182, 184 in the calculating attribute table are equal to the content of the field 191, 192 and 193 respectively in the operand attribute table, an operand is thereby defined in the formula provided in the field 185 in the calculating attribute table. The content of the field 194 in the operand attribute table indicates the order number of the operand within the corresponding formula in the field 185 in the calculating attribute table. Before the calculation can be made, operand values must be taken from some of the lines which are included in the data range, defined as above including the lines that have been calculated within the break concept.

An operand value is taken from some of the lines in the selected data range by means of the contents of fields 195 and 196 in the operand attribute table. For the case of no hit the operand value is set to the value indicated in the field 197 in the operand attribute table. After all operand values have been taken the calculation is made according to the formula indicated in the field 185 in the calculating attribute table.

A new line is created by copying a line within the selected data range, the contents of the following fields being changed before the line is written to the output data file, see FIG. 16:

the content of the field 107 is replaced by the content of the field 184,

the content of the field 108 is replaced by the content of the field 187,

the content of the field 109 is replaced by the calculated value,

the content of the field 110 is replaced by the current time, and

the content of the field 111 is replaced by a code indicating the step in which the record is produced, i.e. the calculating step.

Production of Objects

The purpose of the processing in this step 16 is to produce new objects by taking attributes from other objects. It is suitable to use this function in those cases where one wants to have lists or aggregations, e.g. a list of the employees in an organization unit, summations per business area, etc. The function presupposes that the wanted attributes already exist in the objects which are derived from source data, possibly supplemented with attributes that have been produced in the preceding processing steps.

Input data are as above

the output data file from the preceding processing step, see FIG. 17.

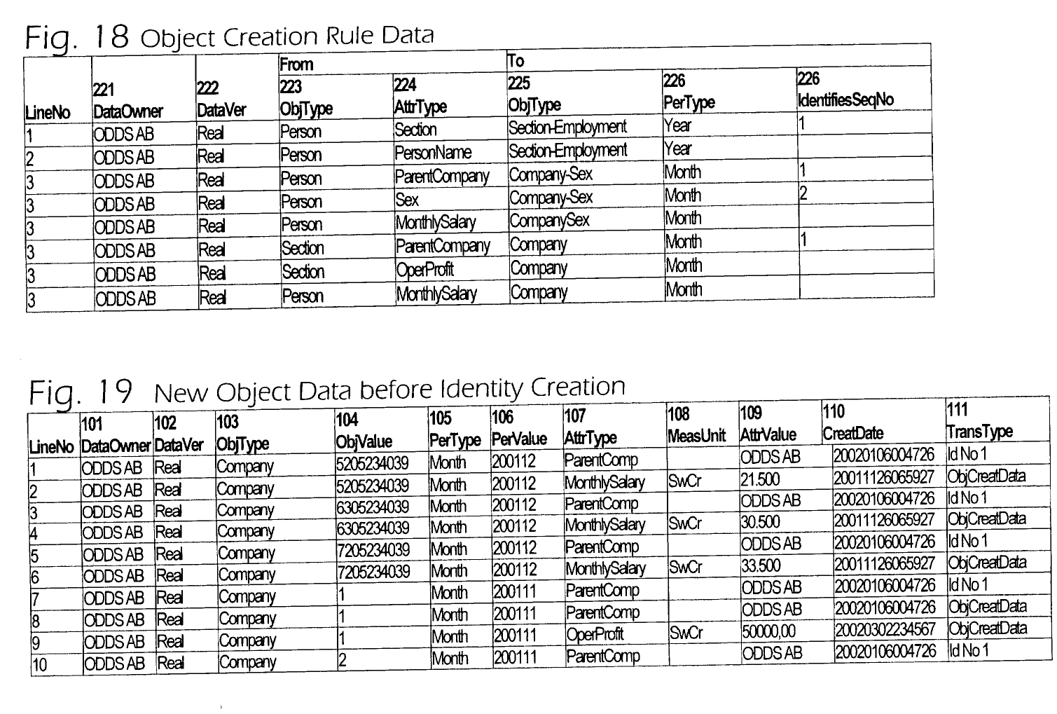

rule data for the object production is indicated in table format, se FIG. 18.

Output data are a data file, see FIG. 21, including the data of the input data file supplemented with new object data that are stored according to the one-dimensional data storing structure.

In the processing is as above a record in the input data file compared to a record in the rule data table. If the contents of the fields 101, 102, 103 and 107 in the input data record are equal to the contents of the fields 221, 222, 223 and 224 respectively in a line in the rule data table, production of a new object is performed. Irrespectively of hit or not hit the input data record is written to the output data file. For the case of a hit the input data record is copied to form a new record, after which in the new record

the content of the field 103 is replaced by the content of the field 225,

the content of the field 105 is replaced by the content of the field 226,

the content of the field 110 is replaced by the time of producing the data, i.e. the current time.

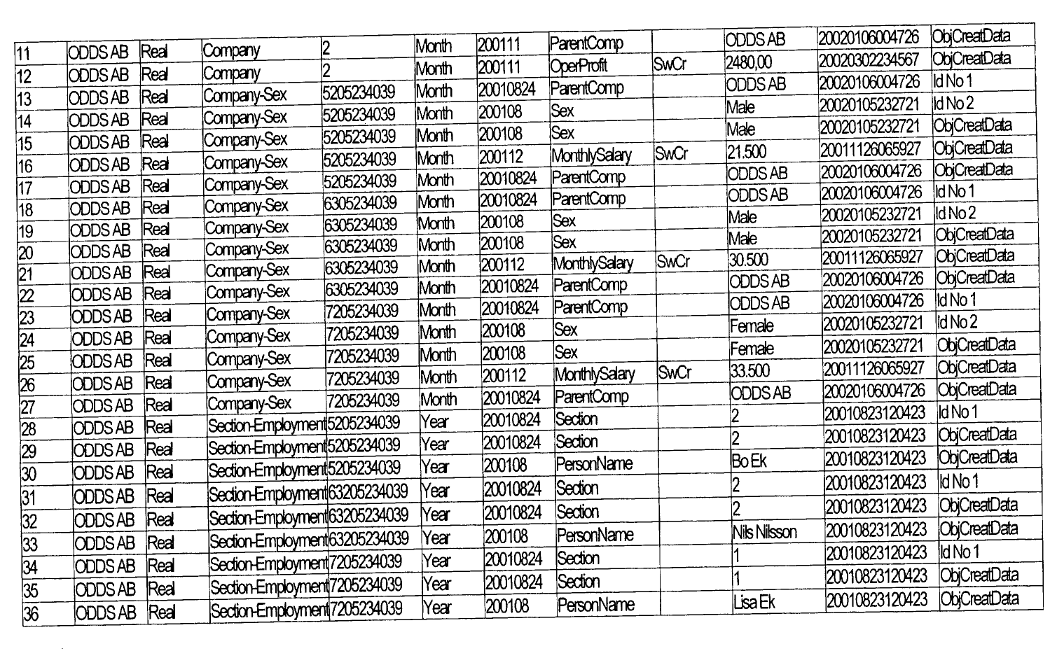

If the new attribute is included in the object identity, as indicated by the content of the field 226, an extra record is written to the output data file, see FIG. 19, after replacing the content of the field 111 by a code for object identity order. Thereupon, the record including the new object attribute is written to the output data file, see FIG. 19, after having replaced the content of the field 111 by a code indicating that the record is produced in the step of object production.

Before the identity production the obtained file is sorted, see FIG. 19, according to the contents in the fields 101, 102, 103, 105, 111 taken in this sequential order. The sorted file, see FIG. 19, is read from its beginning, and then in the lines in which the field 111 contains a code for identifiers

a new object identity is created by means of the content of the field 109 which is then assigned to all subsequent lines that do not belong to the category identifiers according to the field 226.

a new period identity is created from the content of the field 106. This field contains a date according to the format ccyymmddttmmss. The content of the field 105 indicates the size of the time indication, e.g. period type Year is indicated according to the format ccyy, the period type Month is indicated according to the format ccyymm.

The lines not belonging to the category identifiers according to the field 111 obtain the result of the production of object value, field 104, and period value, field 106.

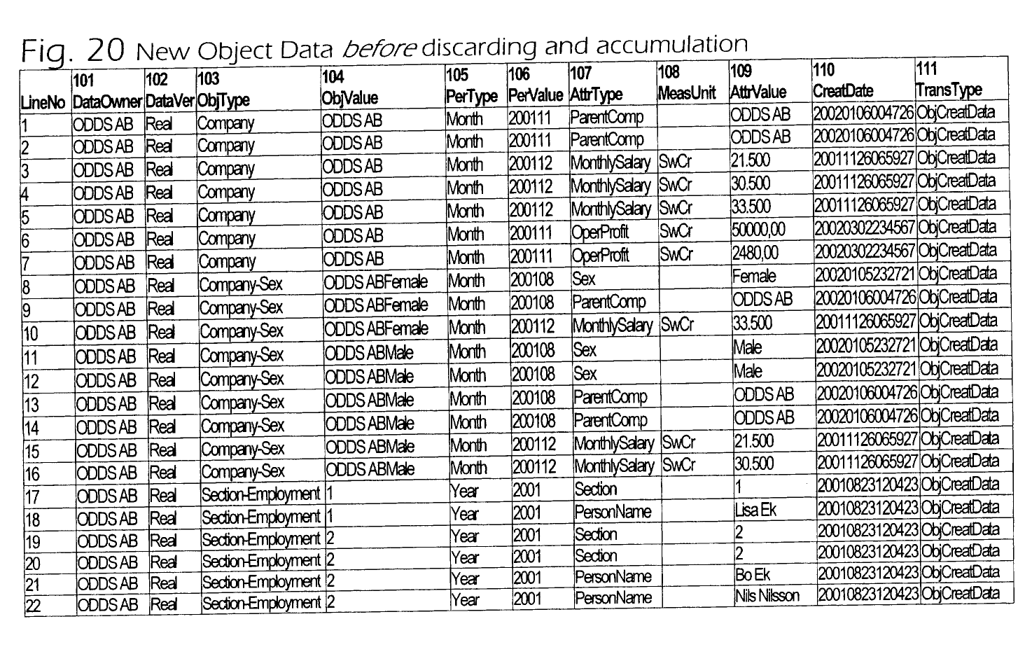

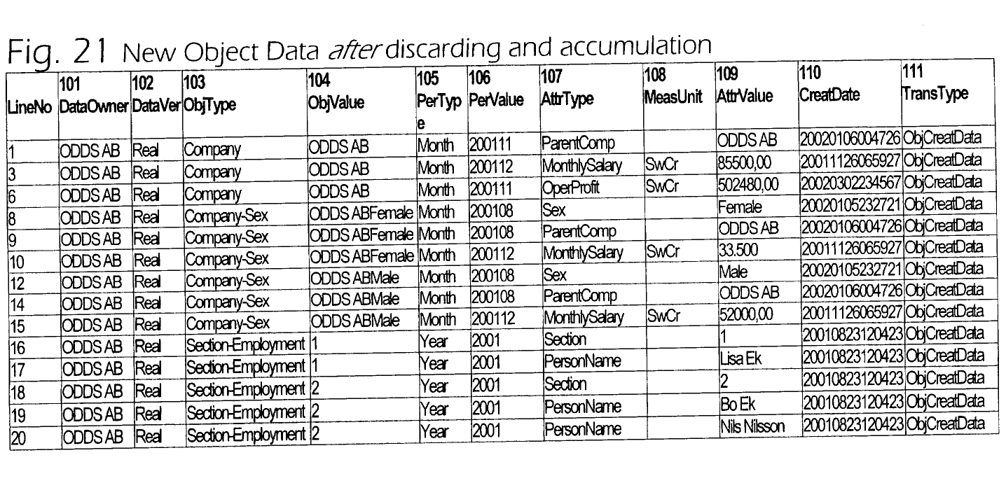

The output data file created by this method, see FIG. 20, is sorted according to the contents of the fields 101, 102, 103, 104, 105, 106, 107 108 and 109. For those records that have attribute values that are of type FIGURES they are added to each other, provided that the records belong to the same category, i.e. have the same contents in the fields 101, 102, 103, 104, 105, 106, 107 and 108.

Records having other attribute values are discarded so that only the oldest record belonging to the same category is saved, i.e. the record that has the same contents in the fields 101, 102, 103, 104, 105, 107, 108 and 109. The remaining records are written to a new output data file, see FIG. 21.

Change of Measurement Unit

The purpose of this processing step 17 is to produce new attributes by executing a recalculation to new measuring units. It is suitable to use this function in standardizing, comparative analyses and for displaying information in the “measurement unit language” of the user.

The input data are as above

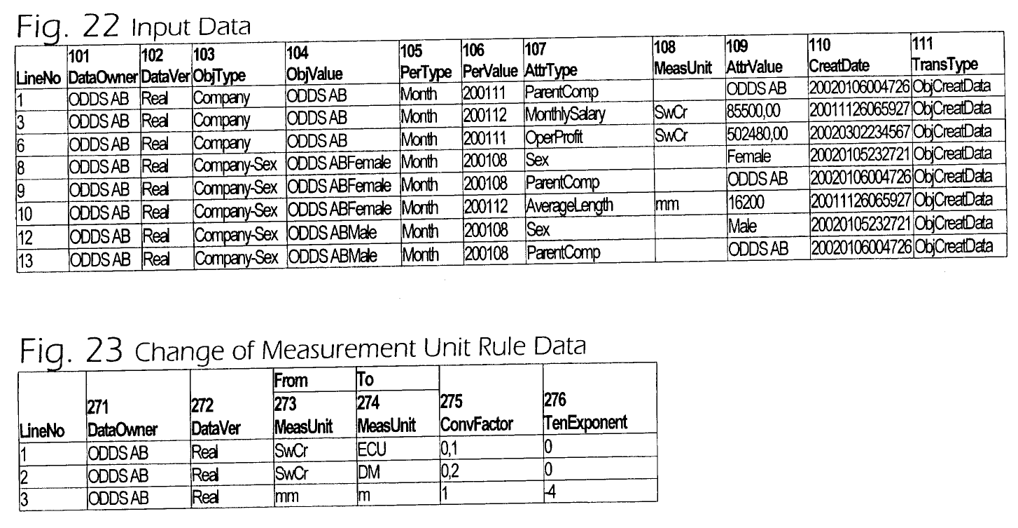

the data file from the preceding step, see FIG. 22.

rule data for change of measurement unit, defined by a table, see FIG. 23.

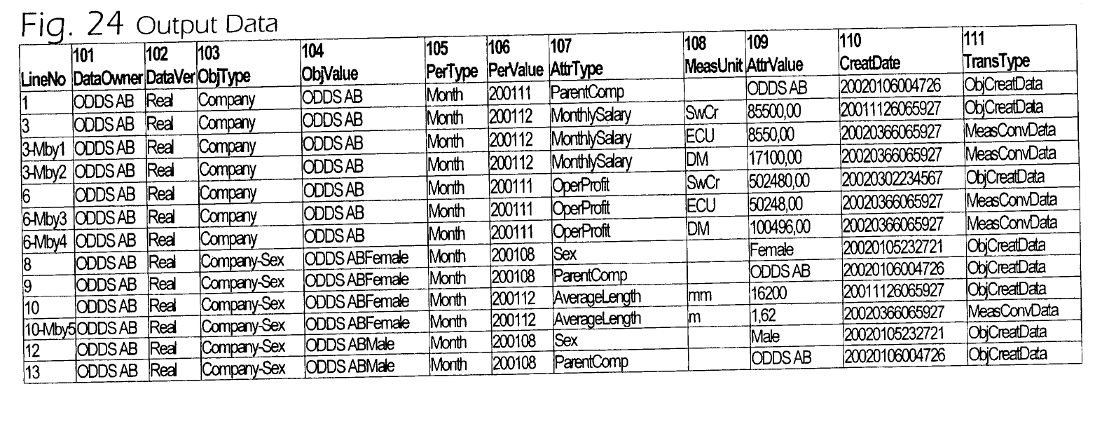

Output data are as above a data file including the data of the input data filed supplemented by new records that contain new values in the fields for measurement unit and attribute value, see FIG. 24.

In the processing a record in the input data file is compared to the first line in the rule data table, thereafter to the second line etc., after which another record in the input data file is compared in the same way, until all records in the input data file have been compared. A change of measurement unit is made in the case where the contents of the fields 101, 102 and 108 in a record in the input data file are equal to the contents of the fields 271, 271 and 273 respectively in the rule data table. Irrespectively of the case of hit or not hit the input data record is written to the output data file. For the case of a hit the input data record is copied to form a new record after which in the new record

the content of the field 108 is replaced by the content of the field 274,

the content of the field 109 is replaced by the value calculated according to the formula [275]*[276]*[109], where the brackets denote the content of a field,

the content of field 110 is replaced by the creation time,

the content of field 111 is replaced by a code indicating that the record has been formed in the measurement conversion step.

For administering and use of the database three types of user interfaces are provided:

A user interface to order data from the data storage

A user interface to maintain the control data for the data processing procedure up to date, i.e. the various tables comprising rule data, se block 34 in FIG. 5b

A user interface for running and monitoring the operation of data system.

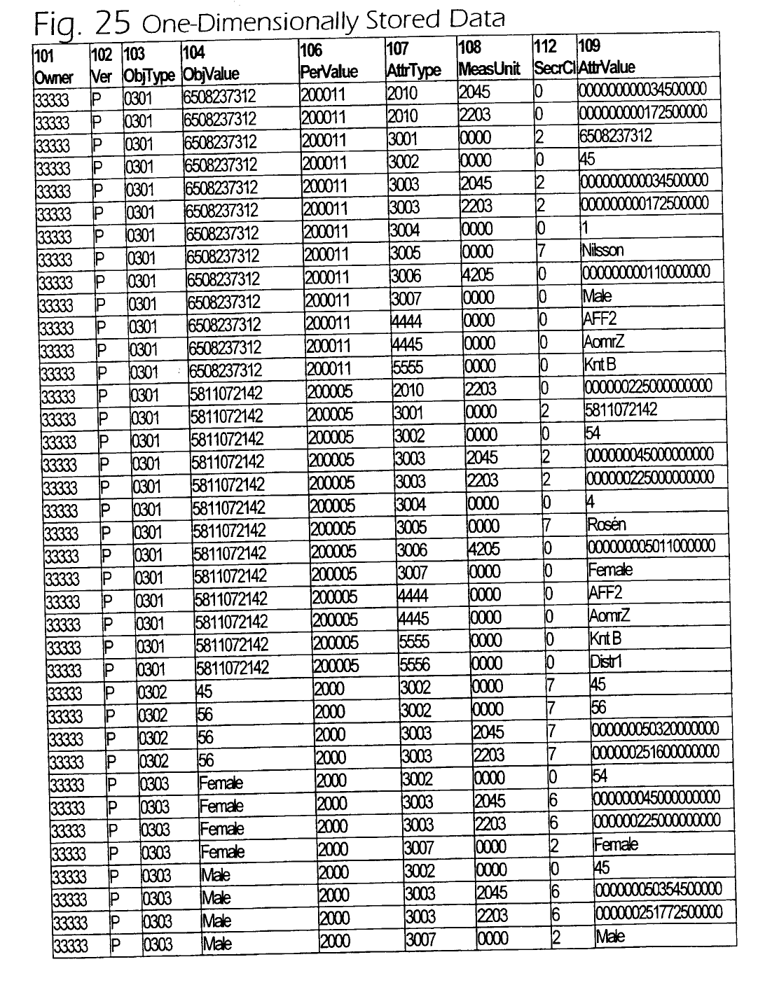

In the user interface, compare block 21 in FIG. 5a, for ordering data, the simplicity of the one-dimensional storing method, obtained by means of the various data processing steps, is most apparently seen. By having all information stored in a standardized identical way, see FIG. 25, it can, using a simple search motor, easily be arranged that a user

obtains access to the attribute types and attribute values to which he is authorized, irrespectively of the production system in which they have been produced, i.e. thereby the created information becoming the common resource of the company.

obtains names and descriptions of objects and attributes displayed in the language of the user by the fact that all entities existing in the fields 101, 102, 103, 106, 107, 108 are encoded in the database so that these entities can in clear language be told in different national languages—thereby the understanding of the stored values is enhanced by the fact that the significance and the meaning of the information can be always displayed.

in a natural way gets access to several generations of data. Thereby history is obtained that can be used to trace event courses or for trend analyses.

obtains a tracing capability in regard of WHERE, WHEN and by WHOM the individual value is created. Thereby, revision history is obtained.

In the data file or database, here also called the data storage 9, obtained after running through all the data processing or manipulation steps, all character based data are stored. For bit based data such as sound and pictures links are provided in the field 109, i.e. addresses of corresponding items, to a particular library for this type of information. A search for desired information can be rapidly done since all relations are already set up, after all data having been processed by the data processing functions. Irrespectively of the information wanted by the user he has only to consider the contents of the following fields:

Field 102: Which data version?

Field 103: Which object type or object types?

Field 106: Which period or periods?

Field 107: Which attribute type or types?

Field 108: Which measurement unit or units?

Field 109: Which attribute value or values?

By the answers to these questions each desired information can be searched from the data storage. Compared to tables in a relational database one has here only to answer to a question in regard of the information desired and does not have to tell where the information is stored.

The user can order information from the data storage 9 to be presented directly through the presentation interface of the system, the “Peeping hole”, compare block 19 in FIG. 5a. The user can also or alternatively demand that ordered information is exported to an arbitrary destination or storing structure, e.g. through electronic mail, and then one or several files in relational data file format are attached to be processed further in for example the computer programs Excel or Access, compare block 23.

When actually storing data in the data file or table having the uniform format numerical codes are used instead of character strings in the cases where it is suitable, mainly in all fields except the field 109 for attribute value, in order to simplify the handling in the processing in the computer, see the table of FIG. 25. In this table all fields are not shown. Instead another field 112 for secrecy class has been added. The use of numerical codes makes it easy to display the contents of records in the table in different languages.

1. A method of extracting desired data from source data comprising attribute values, characterized by the steps of:
storing source data in a uniform format in a single first data table containing a sequence of records that contain values in fields, all records having the same fields and each record containing only one attribute value indicated in a first predetermined field and remaining fields containing information associated with the attribute value, and
processing the records in a sequential order, and then for each record
comparing the contents of first predetermined ones of the remaining field to the contents of the predetermined first fields in a record in a rule data table, and
forming, in the case where equality is determined to exist, from the record a new record that is a copy of the record and thereby has the same uniform format as the records of the first data table, replacing in the new record the contents of second predetermined ones of the fields by the contents of predetermined second fields in the rule data table and storing the new record in the first data table for expanding it,
finally selecting, by a user, at least one of the records stored in the expanded data table in which desired data exist.

2. A method according to claim 1, characterized in that the comparison and the creation of a new record is made for each of a plurality of lines in the rule data table.

3. A method according to claim 1, characterized in that the rule database is given a format containing fields in which at least one of the second predetermined fields agrees with one of the second predetermined ones of the fields of the first data table.

4. A method according to claim 1, characterized in that the rule database is given a format containing fields, in which all the second predetermined fields agree with fields among the second predetermined ones of the fields in the first data table.

5. A method according to claim 1, characterized in that after replacing in the new record, the contents of the first predetermined fields in the new record are compared to the contents of the first predetermined fields in a new line in the rule data table, after which in the case where equality as been determined to exist another new record is created in the same way and that in this new record replacing is made in the same way and storing in the first data table, after which this procedure is repeated for each following row in the rule data table.

6. A method according to claim 5. characterized in that in the case where from a record in the first data table a plurality of new records are formed, from the first data table all these plural new records are removed except that record that has been latest created.

7. A method according to claim 5, characterized in that in the case where from a record in the first data table a plurality of new records are formed, the contents of the fields for attribute value in them are summed to form a sum, after which a new record is formed in the same way as before, after which in its field for attribute value the sum is entered, after which this new record is stored, and that from the first data table all said plural new records are removed except that record that contains the sum.

8. A data storing structure built in table format and arranged to store information for a plurality of objects together with associated attribute values, characterized in that the data storing structure contains a single data table containing a sequence of records that contains values in fields, all records having the same fields and each record containing only one attribute value defined in a first predetermined field and remaining fields contain information that is associated with the object and the attribute value, so that for each individual attribute value there is one and only one line in the data table.

9. A data storing structure according to claim 8, characterized in that the records contain a field for attribute type that defines a type of the attribute value.

10. A data storing structure according to claim 8, characterized in that each record contains fields for storing information associated with the attribute value selected among attribute type, subject association, period association, process association and sort association.

11. A computer system arranged to handle stored information, characterized by means for storing and processing information in the data storing structure according to any of the preceding claims.

12. A method of creating a data storing structure, characterized in that at least two data tables of relational type are combined to form a combined data storing structure according to any of claims 8-10.
